(19) United States
(12) Patent Application Publication
(10) Pub. No.: US 2005/0143160 A1
(43) Pub. Date: Jun. 30, 2005

(54) Method for selecting lottery numbers

(76) Inventors: J. Andre Bowman, Lake Worth, FL (US); Kevin Karle, Shalimar, FL (US)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 10/750,352

(22) Filed: Dec. 31, 2003

(51) Int. Cl. A63F 13/00

(52) U.S. Cl. 463/17

(57) ABSTRACT

There is a system for selecting numbers for a lotto type lottery game. The system is such that each of the n cards includes a first side having a number from 1 to n thereon, and a second side, the second sides of all n cards being identical. The numbers on the front sides of each card are typically different and unique for each card of the n cards. A user selects m cards from the system of n cards, m corresponding to the amount of numbers needed to be selected for the particular lotto type lottery game.

### TECHNICAL FIELD

The present invention is directed to a method and system for selecting lottery numbers. In particular, the present invention is directed to a method and system for selecting numbers for lotto type lottery games.

### BACKGROUND

Lotteries have been known since the earliest days of civilization. In the bible, it is told that Moses used a lottery to award tracts of land west of the Jordan River. Construction of the Great Wall of China is also said to have been funded, at least in part, by a lottery. Lotteries were also used in ancient Rome to fund the government as well as various government projects.

Lotteries flourished throughout Europe between the 15^{th} and 17^{th} centuries. In these national lotteries, countries used the funds to finance wars, roads and other national projects. Lotteries moved to North America with the colonists, but in 1878, were banned in Canada and all U.S. States, except Louisiana. To fill this void, at the beginning of the 20^{th} century, the Queensland State Lottery of Australia and the Irish Sweepstakes becaime available to Americans and Canadians, and proved to be extremely popular.

State lotteries resumed in 1964 with the New Hampshire Sweepstakes. New York and New Jersey followed, with New Jersey implementing the world's first on-line lottery system in 1971. By 1973, lottery sales in the United States surpassed 500 Million Dollars annually. In 1974, Massachusetts instituted the first scratch-off lottery ticket.

The lottery game, known as lotto, where a player selects a number or numbers from single or multiple pools of numbers was introduced by New York and Massachusetts in 1978. This lotto involved players selecting six numbers from 1 to 30 from a single pool of numbers.

In 1996, Georgia, Illinois, Massachusetts, Maryland, Michigan and Virginia combined to start a lotto game known as “The Big Game.” “The Big Game” added New Jersey in 1999, New York, Ohio, Washington in 2002 and Texas in 2003. The “Big Game” changed its name to Mega Millions® in 2002. Mega Millions® is played as players pick six numbers from two separate pools. Five different numbers, from 1 to 52, are selected from the first pool, while one additional number, from 1 to 52, known as the “Mega Ball®” is selected from the second pool. A jackpot is won by matching all six numbers, the first five in any order, plus the “Mega Ball®”. Jackpots start at $10 Million and increase with each drawing should there not be a Jackpot Winner. In 2000, a $363 Million Jackpot was won from this game.

In 1988, the Multi-State Lottery Association (MUSL) began with Oregon, Iowa, Kansas, Rhode Island, West Virginia as members. Presently, the MUSL includes twenty-six member states (including the District of Columbia), and operates various lotto games, including the Powerball™ lotto game.

The Powerball™ lotto game is played as players pick six numbers from two separate pools. Five different numbers, from 1 to 53, are selected from the first pool of white balls, while one additional number, from 1 to 42, known as the Powerball™ number carrying object, is selected from the second pool of red balls. A jackpot is won by matching all six numbers, the first five in any order, plus the Powerball™ number. Jackpots increase should there not be a previous jackpot winner. In 1998, Powerball™ paid a then world record Jackpot of $295.7 million.

Lotto type lottery games are also played in Florida and New York. In Florida, six different numbers, from 1 to 53, are selected by a player. In New York, players select six different numbers, from 1 to 59. Both the Florida and New York Lottos can be played online.

Players typically pick their numbers for these lotto type lottery games with many strategies. Most strategies are random. For example, players use the numbers of theirs or a loved ones birthday, their address, important dates, favorite athletes, or favorite numbers. Players can also select the numbers from dice. Additionally, there are many computer programs that will pick random numbers, these programs typically known as “Quick Picks.” These “Quick Pick” programs are even offered at the retail outlets where the lotto game tickets are purchased. Additionally, there is an “8-Ball” device, that when shaken will show a visible number.

### SUMMARY

The present invention improves on the contemporary methods for picking lottery numbers by providing a method and system for selecting these numbers.

The invention is directed to a system for selecting numbers for a lotto type lottery game having n cards, each of the n cards including a number from 1 to n, with n corresponding to the number of number carrying objects that are eligible to be drawn in the lotto type lottery game. The system is such that each of the n cards includes a first side having a number from 1 to n thereon, and a second side, the second sides of all n cards being identical. The numbers on the front sides of each card are typically different and unique for each card of the n cards.

The invention is also directed to a method for selecting numbers for a lotto type lottery game. This method includes providing n cards, each of the n cards including a number from 1 to n, with n corresponding to the number of number carrying objects that are eligible to be drawn in the lotto type lottery game; and selecting y cards, with y corresponding to the number of number carrying objects that arc drawn (from the eligible number carrying objects) in the lotto type lottery game.

The invention is also directed to a method for selecting numbers for a multiple pool lotto type lottery game. This method includes, providing a first set of n cards, each of the n cards including a number from 1 to n, with n corresponding to the number of number carrying objects that are eligible to be drawn from a first pool of the lotto type lottery game, and selecting y cards, with y corresponding to the number of number carrying objects that are drawn from the first pool (of eligible number carrying objects) of the lotto type lottery game. At least a second set of m cards is provided, each of the n cards including a number from 1 to m, with m corresponding to the number of number carrying objects that are eligible to be drawn from at least one second pool of the lotto type lottery game; and selecting z cards, with z corresponding to the number of number carrying objects that are drawn from the at least one second pool (of eligible number carrying objects) of the lotto type lottery game. For example, five cards are selected by a player from the first set of cards, to correspond to the drawn numbers from first pool, whereby y is 5, while one card is selected by the player from the at least one second set of cards, to correspond to the drawn numbers from the second pool whereby z is 1.

### BRIEF DESCRIPTION OF THE DRAWINGS

Attention is now directed to the drawing figures, where corresponding or like components are indicated by corresponding or like reference numerals or characters. In the drawings:

FIG. 1 is a perspective view of an exemplary use of the system of the present invention; and

FIG. 2 is a front view of a side of an individual member of the system of FIG. 1.

### DETAILED DESCRIPTION OF THE DRAWINGS

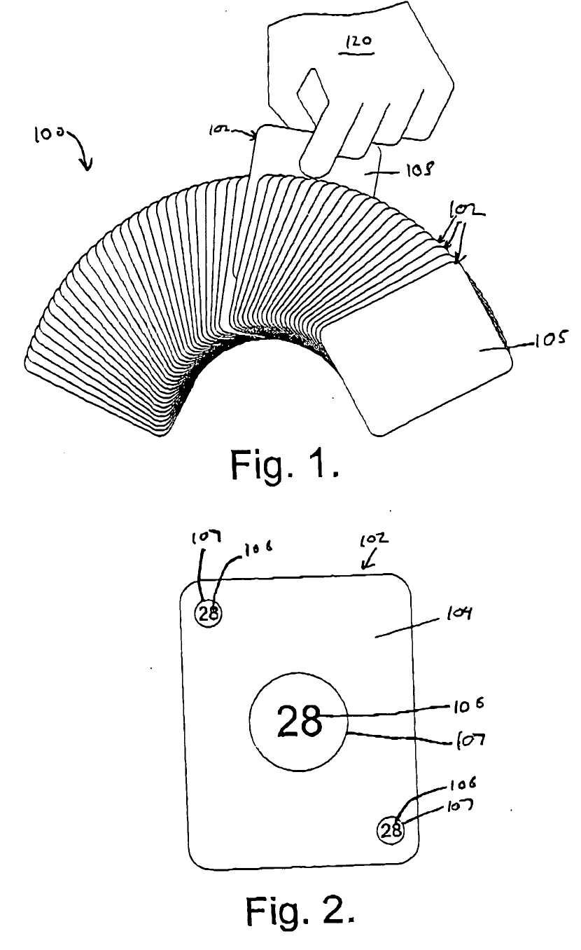

FIG. 1 shows the system 100 of the present invention. This system 100 typically includes a plurality of planar members, for example, cards 102. Turning also to FIG. 2, each card 102 includes a first or front side 104, and a second or rear side 105.

Each front side 104 of the card 102 typically includes a unique number, symbol, character, graphics or combinations thereof For example, the front side 104 of each card 102 of the system 100, typically has a unique number 106 at one or more locations thereon. The unique number 106 is visible to the normal human eye, and may be accompanied by graphics 107, to make this side 104 of the card 102 aesthetically pleasing.

Each rear side 105 of each card 102 is typically identical and uniform in its graphics that define its appearance. This rear side 105 could also be blank and, therefore, uniform, but opaque such that the number 106 and graphics 107 on the first or front side 104 can not be seen or detected through the second or rear side 105.

There are typically a fixed number “n” of cards 102, in the system 100, with “n” being the total number of balls or other number (or symbol) carrying objects, that are eligible to be drawn in the particular lotto type lottery game (by the appropriate lotto game administering authority). Each card 102 typically has a different number 106 on it, that is unique to the individual card. The numbers on each of the cards 102 range from 1 to n, to correspond with each of the “n” balls or other suitable number carrying objects that are eligible to be drawn in the particular lotto type lottery game.

For example, if the specific lotto type lottery game uses balls or other number carrying objects numbered from 1 to 53 (that are eligible to be drawn by the appropriate lotto game administering authority), the system 100 will include 53 cards. Each card will have a different number on the first or front side 104, from 1 to 53, with the rear sides 105 of each card being identical. Each number, from 1 to 53, will be unique to a single card 102, and there will not be any duplicately numbered cards 102 in the system 100.

The cards 102 are typically identical in size and dimensions, so as to be stackable in a deck. The cards 102 are uniform in appearance on their rear or second side 105, so that no single card is distinguishable from any other card in the system 100, when the cards 102 are arranged with their rear sides 105 upward (showing), as shown in FIG. 1.

The cards 102, are typically of a rigid paper or cardboard stock with a lacquered coating, for protection and to inhibit wear and tear on the cards 102. For example, the cards 102 are typically designed of materials that will withstand slight bending due to shuffling, being bound or grouped or the like However, other materials, that would hold printing or graphics and produce rigid cards, are suitable.

The system 100 can be designed for specific lotto type lottery games with a fixed number of “n” cards 102 corresponding to that particular lotto type lottery game. For example, “n” cards would be: 53 cards, numbered 1 to 53 for the Florida Lottery Lotto; 52 cards, numbered 1-52 for the Mega Millions® lotto game (52 cards are used in both pools of this game); and 53 cards, numbered 1-53 for the Powerball™ lotto game (53 cards for selecting numbers from the first pool with only 42 cards, numbered 1-42, used for selecting numbers from the second pool).

Alternately, the system 100 can be made universal, and an exemplary system 100 can include cards numbered to any number “r” so as to be universal to the various lotto games for the various states and associations of states, as well as other national lotto lottery games. Should fewer than “r” cards be needed, to correspond to the “n” cards for a particular lotto game or pool of the lotto game, cards 102 (in excess of “n”) can simply be removed from the system 100 for that particular lotto game or pool.

In an exemplary operation, as shown in FIG. 1, the cards 102 of the system 100 are, for example, initially in a deck. The deck is then shuffled or reorganized in a suitable random arrangement, and, for example, placed in a fan arrangement, with the second or rear sides 105 of all of the cards 102 facing upward. A player or user (illustrated by the hand 120) then selects a certain number of cards, typically corresponding to the number of balls or other number carrying objects, that are drawn for the particular lotto lottery game. Should there be a five number lotto game (five numbers drawn from all of the eligible numbers), the player typically selects five cards. The numbers of the five selected cards are then recorded and the lotto ticket or ticket order is placed with these selected numbers.

Should there be a two pool lotto game, the deck of cards is shuffled a fist time and a player selects a certain number of cards corresponding to the number of balls or number carrying objects to be drawn from the first pool of eligible numbers. The numbers from the selected cards are recorded. The selected cards are returned to the system and the cards are typically shuffled or placed into a suitable random arrangement. The player selects a certain number of cards corresponding to the number of balls or number carrying objects to be drawn from the second pool of eligible numbers. The number(s) of the selected card(s) is/are recorded. A lottery ticket order is then placed with the selected numbers for the first and second pools.

Alternately, should the second pool of the abovementioned two pool lotto game include fewer lotto balls or other number carrying objects than the first pool, the above procedure is repeated, except that cards having numbers corresponding to numbers not included in the second pool are removed from the system. Once the extra cards have been removed, the cards may be shuffled or placed into another suitable random arrangement. The player selects a certain number of cards corresponding to the number of balls or number carrying objects to be drawn from the second pool of eligible numbers. The number(s) of the selected card(s) for this second pool is/are recorded. A lottery ticket order is then placed with the selected numbers for the first and second pools.

Alternately, should the second pool of the abovementioned two pool lotto game include more lotto balls or other number carrying objects than the first pool, the above procedure is repeated, except that cards having numbers corresponding to numbers not included in the first pool are added to the system. Once the extra cards have been added. The cards may be shuffled or placed into another suitable random arrangement. The player selects a certain number of cards corresponding to the number of balls or number carrying objects to be drawn from the second pool of eligible numbers. The number(s) of the selected card(s) for this second pool is/are recorded. A lottery ticket order is then placed with the selected numbers for the first and second pools.

Still alternately, in a two pool lotto game, a player may use one deck of cards to select the numbers for the first pool and another completely new deck to select the number(s) for the second pool.

For example, in typical two pool games such as Mega Millions® and Powerball™, players select five numbers from a fist pool and one number from a second pool. With the system 100, a player selects five cards, providing him with the five numbers for the first pool, and one card, providing him with the one number for the second pool.

In Mega Millions® the number of eligible numbers is 52 for both pools. For example, five cards are selected to provide the player with the first five numbers for the first pool. The selected cards are returned to the deck, and the deck is typically shuffled or placed into another suitable random arrangement. The player then selects one card for the one number to be drawn from the second pool, typically for the Mega Ball®. The numbers of the selected cards are used for the ordered lottery ticket.

In Powerball™ the number of eligible numbers is 53 for the first pool and 42 for the second pool. For example, five cards are selected to provide the player with the first five numbers for the first pool. The selected cards are returned to the deck, cards bearing the numbers 43-53 are removed from the deck and the deck is typically shuffled or placed into another suitable random arrangement. The player then selects one card (from the deck with cards numbered 142) for the one number to be drawn from the second pool, typically for the Powerball™. The numbers of the selected cards are used for the ordered lottery ticket.

There have been shown and described preferred embodiments of systems and methods for selecting lottery numbers. It is apparent to those skilled in the art, however, that many changes, variations, modifications, and other uses and applications for the systems and methods and also such changes, variations, modifications, and other uses and applications which do not depart from the spirit and scope of the invention are deemed to be covered by the invention, which is limited only by the claims which follow.

1. A method for selecting numbers for a lotto type lottery game:
providing n cards, each of the n cards including a number from 1 to n, with n corresponding to the number of number carrying objects that are eligible to be drawn in the lotto type lottery game; and
selecting y cards, with y corresponding to the number of number carrying objects that are drawn in the lotto type lottery game.

2. The method of claim 1, additionally comprising: moving the n cards into a random arrangement.

3. The method of claim 2, wherein the moving the n cards includes shuffling the cards.

4. The method of claim 1, wherein the providing n cards includes providing the n cards in a deck.

5. The method of claim 1, where the number carrying objects include balls, with each ball including a different number 1 to n.

6. A system for selecting numbers for a lotto type lottery game comprising:
n cards, each of the n cards including a number from 1 to n, with n corresponding to the number of number carrying objects that are eligible to be drawn in the lotto type lottery game; and
each of the n cards including a first side having a number from 1 to n thereon and a second side, the second sides of all n cards being identical.

7. The system of claim 6, wherein the cards are of identical shape and dimensions.

8. The system of claim 6, wherein each of the n cards includes a different number from 1 to n.

9. A method for selecting numbers for a multiple pool lotto type lottery game:
providing a first set of n cards, each of the n cards including a number from 1 to n, with n corresponding to the number of number carrying objects that are eligible to be drawn from a first pool of the lotto type lottery game;
selecting y cards, with y corresponding to the number of number carrying objects that are drawn from the first pool of the lotto type lottery game;
providing at least a second set of m cards, each of the m cards including a number from 1 to m, with m corresponding to the number of number carrying objects that are eligible to be drawn from at least one second pool of the lotto type lottery game; and
selecting z cards, with z corresponding to the number of number carrying objects that are drawn from the at least one second pool of the lotto type lottery game.

10. The method of claim 9, wherein the at least one second set of cards is a single set of cards and the at least one second pool is a single second pool.

11. The method of claim 9, wherein n and m are equal.

12. The method of claim 11, wherein y is at least 1.

13. The method of claim 12, wherein y is 5

14. The method of claim 11, wherein z is at least 1.

15. The method of claim 14, wherein z is 1.

16. The method of claim 9, where n and m are not equal.

17. The method of claim 16, wherein providing at least a second set of m cards includes removing cards from the first set of n cards that have numbers not included in the at least one second pool.

18. The method of claim 17, wherein the at least one second set of cards is a single set of cards and the at least one second pool is a single second pool.

19. The method of claim 18, wherein y is at least 1.

20. The method of claim 19, wherein y is 5

21. The method of claim 18, wherein z is at least 1.

22. The method of claim 21, wherein z is 1.

23. The method of claim 9, additionally comprising: moving the n cards and the m cards into respective random arrangements.
